(19) United States
(12) Patent Application Publication
(10) Pub. No.: US 2005/0070644 A1
(43) Pub. Date: Mar. 31, 2005

(54) High molecular weight polyethylene glycol as polymer process aids

(75) Inventors: Tony Tikuisis, Calgary (CA); Gilbert Arnould, Calgary (CA); John Bayley, Calgary (CA); P. Scott Chisholm, Calgary (CA); Sarah Marshall, Calgary (CA)

Correspondence Address: Kenneth H. Johnson;Patent Attorney, P.O. Box 630708, Houston, TX, 77263, US

(73) Assignee: NOVA Chemicals (International) S.A.

(21) Appl. No.: 10/944,935

(22) Filed: Sep. 20, 2004

(30) Foreign Application Priority Data
Sep. 26, 2003 (CA) 2,442,789

(51) Int. Cl. C08L 1/00

(52) U.S. Cl. 524/115; 524/386; 524/117

(57) ABSTRACT

A polymer process aid (PPA) for reducing melt defects in extruded polyethylene in the absence of fluoropolymers. The PPA is inexpensive and is also very effective for the reduction of extruder pressures. The PPA functions especially well for the extrusion of linear low density polyethylene.

### FIELD OF THE INVENTION

The present invention relates to process aids for the extrusion of polyolefin parts having a reduced level of surface imperfections.

### BACKGROUND OF THE INVENTION

In the manufacture of extruded polymers there are a number of surface defects referred to as sharkskin, snakeskin and orange peel which all generally related to the rheology of the polymer melt. A severe form of surface defect is “melt fracture” which is believed to result when the shear rate at the surface of the polymer is sufficiently high that the surface of the polymer begins to fracture. That is, there is a slippage of the surface of the extruded polymer relative to the body of the polymer melt. The surface generally can't flow fast enough to keep up with the body of the extrudate and a fracture in the melt occurs generally resulting in a severe loss of surface properties for the extrudate.

U.S. Pat. No. 3,125,547 issued Mar. 17, 1964 assigned to E.I. DuPont du Nemours and Company discloses blends of polyethylene and small amounts of fluoropolymers to provide a smooth surface on extrudate at high extrusion speeds.

U.S. Pat. No. 3,222,314 issued Dec. 7, 1965, assigned to E.I. DuPont du Nemours and Company discloses blends of polyethylene and low molecular weight polyethylene glycol to provide heat sealable film suitable for printing.

U.S. Pat. No. 4,013,622 (DeJuneas et al.) teaches the use of low molecular weight polyethylene glycol to reduce the incidence of “breakdowns” during the manufacture of polyethylene film.

Similarly, U.S. Pat. No. 4,540,538 (Corwin et al.) teaches that pinstriping may be reduced during the extrusion of polyolefin film through the use of a combination of (i) low molecular weight polyethylene glycol; (ii) a hindered phenolic antioxidant; and (iii) a selected inorganic antiblock.

There are a series of patents in the name of the Minnesota Mining and Manufacturing Company relating to the use of a combination of polyalkylene oxides and fluorocarbon polymers as a process aid in extrusion of polyolefins. These patents include U.S. Pat. No. 4,855,360 issued Aug. 8, 1989 which discloses and claims a composition of matter comprising the polyolefin and the process aid; and U.S. Pat. No. 5,015,693 which claims the process aid per se. These patents teach that polyethylene glycols, regardless of molecular weight, do not delay the onset of melt defects. In contrast, we have discovered that high molecular weight polyethylene glycol (having a molecular weight of greater than 20,000) reduces melt fracture during polyolefin extrusions in the absence of fluoropolymers. Moreover, the inventors have also discovered that the use of high molecular weight polyethylene glycol may improve gauge variation in films produced by blown film extrusion (i.e. variation in film thickness is reduced) and may also reduce extruder pressures in comparison to prior art process aids.

### SUMMARY OF THE INVENTION

In one embodiment the invention provides an extrudable composition for the manufacture of thermoplastic film comprising:
A) a thermoplastic polyolefin polymer; and
B) from 100 to 2000 parts per million by weight of polyethylene glycol; characterized in that said polyethylene glycol has a weight average molecular weight of from 10,000 to 50,000,
   and further characterized in that said composition is substantially free of fluoropolymer.

### DETAILED DESCRIPTION

The major or predominant component in the compositions of the present invention is an extrudable polymer. The predominant component is present in an amount of at least about 98% by weight (weight %) of the base composition. That is, the composition may include pigments and fillers in a typical amount but they would not be considered a part of the base component.

The extrudable polymer may be a number of extrudable polymers such as polyolefins including those substituted by an aromatic radical (e.g. styrene) or an unsubstituted polyolefin such as polyethylene or a copolymer such as an ethylene alpha olefin copolymer. Typically the olefin polymer (or “polyolefin”) comprises at least 85 weight % of one or more C₂₋₃ alpha olefins and up to 15 weight % of one or more C₄₋₈ alpha olefins. Preferably, the polyolefin comprises at least 90 weight % of ethylene and up to 10 weight % of one or more C₄₋₈ alpha olefins. Suitable C₂₋₃ alpha olefins are ethylene and propylene. Suitable C₄₋₈ alpha olefins include butene, 4-methyl pentene, hexene and octene.

The polyolefin may be prepared by conventional processes. In the case of olefins substituted by aromatic radicals such as styrene the polymer may be polymerized in a bulk or solution polymerization initiated either thermally or by free radical polymerization. In the case of unsubstituted olefin polymers the polymerization may be in gas phase (that is at relatively low pressures below 500 psi, preferably below about 250 psi; at temperatures below about 130° C., and using a particulate catalyst in a fluidized bed such as the process patented by Union Carbide Corporation), to produce products such as high density (e.g. having a density greater than 0.935, preferably greater than 0.940 g/cc) and low density polyethylene (having a density from about 0.910 to 0.935 g/cc); in solution (a process at high temperatures typically from about 130 to about 250, preferably not greater than about 220° C., comprising dissolving ethylene and other comonomer(s) in a solvent such as hexane and the presence of a coordination catalyst such as that disclosed in a number of patents in the name of DuPont) (either low pressure low to medium density polyethylene or high pressure low density polyethylene) or slurry polymerization (such as polypropylene or ethylene copolymers) initiated by a co-ordination catalyst or in the case of high pressure polymerization by free radicals. The use of single site catalysts (including so-called metallocene catalysts and “constrained geometry catalysts”) is also contemplated. The details of such types of catalysts and polymerizations are generally known to those skilled in the art.

Depending on the type of polymerization and the olefin, the olefin polymer may have a molecular weight (weight average—Mw) from about 100,000 up to 1,000,000, typically from about 150,000 to 350,000.

The invention is useful for thermoplastic polyolefins in general but is particularly well suited for improving the extrusion of linear polyethylene, especially linear low density polyethylene or LLDPE. LLDPE is a copolymer of ethylene with another copolymerizable alpha olefin (such as the aforementioned butene, hexene or octene) which has a density of less than 0.955 grams per cubic centimeter. Such LLDPEs are well known items of commerce and may be prepared by conventional polymerization processes.

LLDPE is often characterized by density and melt index, I₂ (as determined by ASTM D1238, Condition E, at 190° C.). Preferred LLDPE has a density of from 0.900 to 0.950 grams per cubic centimeter, and a melt index, I₂, of from 0.3 to 5.0 grams/10 minutes.

Depending on the type of polymerization, the olefin polymer may have a molecular weight (weight average—“Mw”) from about 10,000 up to 1,000,000, typically from about 100,000 to 350,000. More than one type of polymer may be present in the extrudable compositions.

The present invention includes the use of a high molecular weight polyethylene glycol (PEG) as an essential component. The PEG must have a weight average molecular weight of at least 20,000, preferably from 25,000 to 50,000. The use of lower molecular weight PEG does not provide satisfactory results as noted in U.S. Pat. No. 4,855,360. PEG having a molecular weight of higher than 50,000 is generally more expensive (and is believed to be more prone to degradation via a chain-scission mechanism) in comparison to the preferred PEGs. Near derivatives of the PEG (such as simple ethers of PEG) may also be employed but PEG, per se, is preferred. Suitable high molecular weight PEG is commercially available under the trademark Polyglykol.

The amount of polyethylene glycol used will preferably be between 200 and 2,000 parts per million by weight (based on the weight of the polyolefin). Optimal addition levels for a given extrusion process may be readily determined by those skilled in the art.

The present invention is further characterized by the substantial absence of any fluoroelastomer in the extruded compositions. Fluroelastomer is an expensive material so there is an economic incentive to avoid its use. [Note: It is believed that the high molecular weight PEG would still function in the presence of the fluoroelastomer.]

The thermoplastic polyolefin-containing compositions of the present invention may further include fillers, antioxidants (at least a primary and optionally a secondary antioxidant), pigments, opacifying agents, static control agents such as glycerol monostearate and/or low molecular weight polyethylene glycol (e.g. CARBOWAX 8000, sold by Union Carbide Corporation), lubricants such as fatty acid esters, light stabilizers (such as hindered amine light stabilizers), zinc oxide, antiblock agents and other adjuvants. Some care must be taken when using antiblock agents (such as silica or talc) and/or hindered amine light stabilizers as these may have an adverse effect upon the surface appearance of the polyolefin extrudate—as is known to those skilled in the art.

The present invention is generally useful for the extrusion of polyolefins in a wide variety of extrusion processes such as profile extrusion in which an extruded part such as a pipe or profiled part is prepared by extruding molten plastic through a shaped die) and film extrusion (in which plastic film is prepared by extruding molten plastic through a slit or annular die). Film extrusion, especially the so-called “blown film process” which is described in more detail in the examples, is preferred.

For film applications, preferably no pigment or filler is added and the film is clear or relatively clear. In other applications such as wire and cable (electrical or optical) the compound may contain a pigment/filler such as carbon black and other adjuvants (in these types of applications the unsubstituted olefin polymer may be grafted by extrusion with a functional ethylenically unsaturated monomer such as maleic anhydride in the presence of a free radical agent such as a peroxide).

Typically if an antioxidant (primary alone or optionally in combination with a secondary antioxidant) is used in an amount from about 0.01 to 2, preferably 0.01 to about 1 weight %. Fillers may be incorporated into the compositions of the present invention in amounts up to about 50%, preferably less than about 30%. Further descriptions of conventional additives for polyolefins are provided below.

1. Primary Antioxidants

1.1 Alkylated Mono-Phenols

For example, 2,6-di-tert-butyl-4-methylphenol; 2-tert-butyl4,6-dimethylphenol; 2,6-di-tert-butyl-4-ethylphenol; 2,6-di-tert-butyl-4-n-butylphenol; 2,6-di-tert-butyl4 isobutylphenol; 2,6-dicyclopentyl-4-methylphenol; 2-(alpha.-methylcyclohexyl)4,6 dimethylphenol; 2,6-di-octadecyl-4-methylphenol; 2,4,6,-tricyclohexyphenol; and 2,6-di-tert-butyl-4-methoxymethylphenol.

1.2 Alkylated Hydroquinones

For example, 2,6di-tert-butyl-4-methoxyphenol; 2,5-di-tert-butylhydroquinone; 2,5-di-tert-amyl-hydroquinone; and 2,6diphenyl-4-octadecyloxyphenol.

1.3 Hydroxylated Thiodiphenyl Ethers

For example, 2,2′-thio-bis-(6-tert-butyl-4-methylphenol); 2,2′-thio-bis-(4-octylphenol); 4,4′thio-bis-(6-tertbutyl-3-methylphenol); and 4,4′-thio-bis-(6-tert-butyl-2-methylphenol).

1.4 Alkylidene-Bisphenols

For example, 2,2′-methylene-bis-(6-tert-butyl-4-methylphenol); 2,2′-methylene-bis-(6-tert-butyl-4-ethylphenol); 2,2′-methylene-bis-(4-methyl-6-(alpha-methylcyclohexyl)phenol); 2,2′-methylene-bis-(4-methyl-6-cyclohexylphenol); 2,2′-methylene-bis-(6-nonyl-4-methylphenol); 2,2′-methylene-bis-(6-nonyl-4-methylphenol); 2,2′-methylene-bis-(6-(alpha-methylbenzyl)-4-nonylphenol); 2,2′-methylene-bis-(6-(alpha, alpha-dimethylbenzyl)-4-nonyl-phenol); 2,2′-methylene-bis-(4,6-di-tert-butylphenol); 2,2′-ethylidene-bis-(6-tert-butyl-4-isobutylphenol); 4,4′methylene-bis-(2,6-di-tert-butylphenol); 4,4′-methylene-bis-(6-tert-butyl-2-methylphenol); 1,1-bis-(5-tert-butyl-4-hydroxy-2-methylphenol)butane 2,6-di-(3-tert-butyl-5-methyl-2-hydroxybenzyl)-4-methylphenol; 1,1,3-tris-(5-tert-butyl-4-hydroxy-2-methylphenyl)butane; 1,1-bis-(5-tert-butyl-4-hydroxy2-methylphenyl)-3-dodecyl-mercaptobutane; ethyleneglycol-bis-(3,3,-bis-(3′-tert-butyl4′-hydroxyphenyl)-butyrate)-di-(3-tert-butyl-4-hydroxy-5-methylpenyl)-dicyclopentadiene; di-(2-(3′-tert-butyl-2′hydroxy-5′methylbenzyl)-6-tert-butyl-4-methylphenyl)terephthalate; and other phenolics such as monoacrylate esters of bisphenols such as ethylidiene bis-2,4-di-t-butylphenol monoacrylate ester.

1.5 Benzyl Compounds

For example, 1,3,5-tris-(3,5-di-tert-butyl-4-hydroxybenzyl)-2,4,6-trimethylbenzene; bis-(3,5-di-tert-butyl-4-hydroxybenzyl)sulfide; isooctyl 3,5-di-tert-butyl-4-hydroxybenzyl-mercaptoacetate; bis-(4-tert-butyl-3hydroxy-2,6-dimethylbenzyl)dithiol-terephthalate; 1,3,5-tris-(3,5-di-tert-butyl-4,10 hydroxybenzyl)isocyanurate; 1,3,5-tris-(4-tert-butyl-3-hydroxy-2,6-dimethylbenzyl)isocyanurate; dioctadecyl 3,5-di-tert-butyl-4-hydroxybenzylphosphonate; calcium salt of monoethyl 3,5-di-tertbutyl-4-hydroxybenzylphosphonate; and 1,3,5-tris-(3,5-dicyclohexyl-4-hydroxybenzyl)isocyanurate.

1.6 Acvlaminophenols

For example, 4-hydroxy-lauric acid anilide; 4-hydroxy-stearic acid anilide; 2,4-bis-octylmercapto-6-(3,5-tert-butyl-4-hydroxyanilino)-s-triazine; and octyl-N-(3,5-di-tert-butyl-4-hydroxyphenyl)-carbamate.

1.7 Esters of beta-(5-tert-butyl-4-hydroxy-3-methylphenyl)-Propionic Acid with Monohydric or Polyhydric Alcohols

For example, methanol; diethyleneglycol; octadecanol; triethyleneglycol; 1,6-hexanediol; pentaerythritol; neopentylglycol; tris-hydroxyethyl isocyanurate; thidiethyleneglycol; and dihydroxyethyl oxalic acid diamide.

1.8 Amides of beta-(3,5-di-tert-butyl-4-hydroxyphenol)-propionic Acid

For example, N,N′-di-(3,5-di-tert-butyl-4-hydroxyphenylpropionyl)-hexamethylendiamine; N,N′-di-(3,5-di-tert-butyl-4-hydroxyphenylpropionyl)trimethylenediamine; and N,N′-di(3,5-di-tert-butyl-4-hydroxyphenylpropionyl)-hydrazine.

2. UV Absorbers and Light Stabilizers

2.1 2-(2′-hydroxyphenyl)-benzotriazoles

For example, the 5′-methyl-,3′5′-di-tert-butyl-,5′-tert-butyl-,5′(1,1,3,3-tetramethylbutyl)-,5-chloro-3′,5′-di-tert-butyl-,5-chloro-3′-tert-butyl-5′-methyl-3′-sec-butyl-5′-tert-butyl-,4′-octoxy,3′,5′-ditert-amyl-3′,5′-bis-(alpha, alpha-di methylbenzyl)-derivatives.

2.2 2-Hydroxy-Benzophenones

For example, the 4-hydroxy4-methoxy-,4-octoxy,4-decyloxy-,4dodecyloxy-,4-benzyloxy,4,2′,4′-trihydroxy-and 2′-hydroxy-4,4′-dimethoxy derivative.

2.3 Esters of Substituted and Unsubstituted Benzoic Acids

For example, phenyl salicilate; 4-tertbutylphenyl-salicilate; octylphenyl salicylate; dibenzoylresorcinol; bis-(4-tert-butylbenzoyl)-resorcinol; benzoylresorcinol; 2,4-di-tert-butyl-phenyl-3,5-di-tert-butyl-4-hydroxybenzoate; and hexadecyl-3,5-di-tert-butyl-4-hydroxybenzoate.

2.4 Acrylates

For example, alpha-cyano-.beta,.beta.-diphenylacrylic acid-ethyl ester or isooctyl ester; alpha-carbomethoxy-cinnarnic acid methyl ester; alpha-cyano-.beta.-methyl-p-methoxy-cinnamic acid methyl ester or butyl ester; alpha-carbomethoxy-p-methoxy-cinnamic acid methyl ester; and N-(beta-carbomethoxy-beta-cyano-vinyl)-2-methyl-indoline.

2.5 Nickel Compounds

For example, nickel complexes of 2,2′-thio-bis(4-(1,1,1,3-tetramethylbutyl)-phenol), such as the 1:1 or 1:2 complex, optionally with additional ligands such as n-butylamine, triethanolamine or N-cyclohexyl-diethanolamine; nickel dibutyldithiocarbamate; nickel salts of 4-hydroxy-3,5-di-tert-butylbenzylphosphonic acid monoalkyl esters, such as of the methyl, ethyl, or butyl ester; nickel complexes of ketoximes such as of 2-hydroxy-4-methyl-penyl undecyl ketoxime; and nickel complexes of 1-phenyl-4-lauroyl-5-hydroxy-pyrazole, optionally with additional ligands.

2.6 Sterically Hindered Amines

For example, bis (2,2,6,6-tetramethylpiperidyl)-sebacate; bis-5 (1,2,2,6,6-pentamethylpiperidyl)-sebacate; n-butyl-3,5-di-tert-butyl-4-hydroxybenzyl malonic acid bis(1,2,2,6,6,-pentamethylpiperidyl)ester; condensation product of 1-hydroxyethyl-2,2,6,6-tetramethyl-4-hydroxy-piperidine and succinic acid; condensation product of N,N′-(2,2,6,6-tetramethylpiperidyl)-hexamethylendiamine and 4-tert-octylamino-2,6-dichloro-1,3,5-s-triazine; tris-(2,2,6,6-tetramethylpiperidyl)-nitrilotriacetate, tetrakis-(2,2,6,6-tetramethyl-4-piperidyl)-1,2,3,4butane-tetra-arbonic acid; and 1,1′(1,2-ethanediyl)-bis-(3,3,5,5-tetramethylpiperazinone). These amines typically called HALS (Hindered Amines Light Stabilizing) include butane tetracarboxylic acid 2,2,6,6-tetramethyl piperidinol esters. Such amines include hydroxylamines derived from hindered amines, such as di(1-hydroxy-2,2,6,6-tetramethylpiperidin-4-yl) sebacate; 1-hydroxy 2,2,6,6-tetramethyl-4-benzoxypiperidine; 1-hydroxy-2,2,6,6-tetramethyl-4-(3,5-di-tert-butyl-4-hydroxy hydrocinnamoyloxy)-piperdine; and N-(1-hydroxy-2,2,6,6-tetramethyl-piperidin-4-yl)-epsiloncaprolactam.

2.7 Oxalic Acid Diamides

For example, 4,4′-di-octyloxy-oxanilide; 2,2′-di-octyloxy-5′,5′-ditert-butyloxanilide; 2,2′-di-dodecyloxy-5′,5′di-tert-butyl-oxanilide; 2-ethoxy-2′-ethyl-oxanilide; N,N′-bis(3-dimethylaminopropyl)-oxalamide; 2-ethoxy-5-tert-butyl-2′-ethyloxanilide and its mixture with 2-ethoxy-2′-ethyl-5,4-di-tert-butyloxanilide; and mixtures of ortho-and para-methoxy as well as of o- and p-ethoxy-disubstituted oxanilides.

2.8 HydroxyPhenyl-s-triazines

For example, 2,6-bis-(2,4-dimethylphenyl)-4-(2-hydroxy-4octyloxyphenyl)-s-triazine; 2,6-bis(2,4-dimethylphenyl)-4-(2,4-dihydroxyphenyl)-s-triazine; 5 2,4-bis(2,4-dihydroxyphenyl)-6-(4-chlorophenyl)-s-triazine; 2,4-bis(2-hydroxy4-(2-hydroxyethoxy)phenyl)-6-(4-chlorophenyl)-s-triazine; 2,4-bis(2hydroxy4-(2-hydroxyethoxy)phenyl)-6-phenyl-s-triazine; 2,4-bis(2-hydroxy4-(2-hydroxyethoxy)-phenyl)-6-(2,4-dimethylphenyl)-s-tri azine; 2,4-bis(2-hydroxy4-(2-hydroxyethoxy)phenyl)-6-(4-bromo-phenyl)-s-triazine; 2,4-bis(2-hydroxy4-(2-acetoryethoxy)phenyl)-6-(4-chlorophenyl)-s-triazine; and 2,4-bis(2,4-dihydroxyphenyl)-6-(2,4-dimethylphenyl)-1-s-triazine.

3. Metal Deactivators

For example, N,N′diphenyloxalic acid diamide; N-salicylal-N′-salicyloylhydrazine; N,N′-bis-salicyloylhydrazine; N,N′-bis-(3,5-di-tert-butyl-4-hydrophenylpropionyl)-2-hydrazine; salicyloylamino-1,2,4-triazole; and bis-benzyliden-oxalic acid dihydrazide.

4. Secondary Antioxidants

4.1 Phosphites and Phosphonites

For example, triphenyl phosphite; diphenylalkyl phosphates; phenyldialkyl phosphates; tris(nonyl-phenyl)phosphite; trilauryl phosphite; trioctadecyl phosphite; distearyl pentaerythritol diphosphite; tris(2,4-di-tert-butylphenyl)phosphite; diisodecyl pentaerythritol diphosphite; 2,4,6-tri-tert-butylphenyl-2-butyl-2-ethyl-1,3-propanediol phosphite; bis(2,4-di-tert-butylphenyl)pentaerythritol diphosphite tristearyl sorbitol triphosphite; and tetrakis(2,4-di-tert-butylphenyl)4,4′-biphenylene diphosphonite.

4.2 Peroxide Scavengers

For example, esters of betathiodipropionic acid, for example the lauryl, stearyl, myristyl or tridecyl esters; mercaptobenzimidazole or the zinc salt of 2-mercaptobenzimidazole; zinc-dibutyidithiocarbamate; dioctadecyidisulfide; and pentaerythritottetrakis-(beta-dodecylmercapto)-propionate.

4.3 Hydroxylamines and Amine Oxides

For example, N,N-dibenzylhydroxylamine; N,N-diethylhydroxylamine; N,N-dioctylhydroxylamine; N,N-dilaurylhydroxylamine; N,N-ditetradecylhydroxylamine; N,N-dihexadecylhydroxylamine; N,N-dioctadecylhydroxylamine; N-hexadecyl-N-octadecylhydroxylamine; N-heptadecyl-N-octadecylhydroxylamine; and N,N-dialkylhydroxylamine derived from hydrogenated tallow amine. The analogous amine oxides are also suitable.

4.4 Nitrones

For example, N-benzyl-alpha-phenyl nitrone; N-ethyl-alpha-methyl nitrone; N-octyl-alpha-heptyl nitrone; N-lauryl-alpha-undecyl nitrone; N-tetradecyl-alpha-tridecyl nitrone; N-hexadecyl-alpha-pentadecyl nitrone; N-octadecyl-alpha-heptadecyInitrone; N-hexadecyl-alpha-heptadecyl nitrone; N-octadecyl-alpha-pentadecyl nitrone; N-heptadecyl-alpha-heptadecyl nitrone; N-octadecyl-alpha-hexadecyl nitrone; and nitrone derived from N,N-dialkylhydroxylamine derived from hydrogenated tallow amine.

4.5 Polyamide Stabilizers

For example, copper salts in combination with iodides and/or phosphorus compounds and salts of divalent manganese.

4.6 Basic Co-stabilizers

For example, melamine; polyvinylpyrrolidone; dicyandiamide; triallyl cyanurate; urea derivatives; hydrazine derivatives; amines; polyamides; polyurethanes; alkali metal salts and alkaline earth metal salts of higher fatty acids, for example, Ca stearate, calcium stearoyl lactate, calcium lactate, Zn stearate, Mg stearate, Na ricinoleate and K palmitate; antimony pyrocatecholate or zinc pyrocatecholate, including neutralizers such as hydrotalcites and synthetic hydrotalcites; and Li, Na, Mg, Ca, Al hydroxy carbonates.

4.7 Nucleating Agents

For example, 4-tert-butylbenzoic acid; adipic acid; diphenylacetic acid; sodium salt of methylene bis-2,4-dibutylphenyl; cyclic phosphate esters; sorbitol tris-benzaldehyde acetal; and sodium salt of bis(2,4-di-t-butylphenyl) phosphate or Na salt of ethylidene bis(2,4-di-t-butyl phenyl)phosphate. Nucleating agents may improve stiffness of the rotomolded part. However, some nucleating agents which contain an aromatic group may also increase sintering time (as illustrated in the examples).

4.8 Fillers and Reinforcing Agents

For example, calcium carbonate; silicates; glass fibers; asbestos; talc; kaolin; mica; barium sulfate; metal oxides and hydroxides; carbon black; and graphite.

4.9 Other Additives

For example, plasticizers; epoxidized vegetable oils, such as epoxidized soybean oils; lubricants; emulsifiers; pigments; optical brighteners; flameproofing agents; anti-static agents; blowing agents and thiosynergists, such as dilaurythiodipropionate or distearylthiodipropionate.

Typically, the extrudable polymer compositions of the present invention will be prepared by melt blending prior to final extrusion. There are several methods which could be used to produce the compositions of the present invention. All the components may be dry blended in the required weight ratio in a suitable device such as a tumble blender. The resulting dry blend is then melted in suitable equipment such as an extruder. Alternatively, a masterbatch could be prepared with some of the polyolefin and the other ingredients. The masterbatch is then fed to an extruder and melt blended. In a third method the dry components of the blend may be metered directly into an extruder.

The extruder may be a twin or single screw extruder. If it is a twin screw extruder it may be operated in a co-rotating mode (i.e. both screws turning in the same direction) or in a counter rotating mode (i.e. the screws rotate in opposite directions).

The specific conditions for operation of any extruder will differ from that of any other extruder. The variations between machines may usually be resolved by non-inventive testing. Typically, laboratory twin screw extruders will operate within the following envelope of conditions. The barrel will be heated to a temperature from about 180 to 210, preferably from 190 to 200° C. The screw speed will normally be from 50 to 150, preferably from 100 to 130 RPM's. As noted above the specific conditions for the operation of any specific extruder can readily be determined by one skilled in the art by non-inventive testing in view of the above envelope of conditions.

The extruder will typically extrude the polymer composition as strands which are then cooled and cut into pellets for subsequent use, typically film extrusion.

The extruder used for the final extrusion may also be a single or twin screw extruder. The die may be a slot die or it may be an annular ring die extruding a film of the polymer blend about a stable bubble of air. The film is collapsed after passing over or about the bubble.

Extruders for thermoplastic polyolefins and extrusion processes which employ these extrudes are well known to those skilled in the art. A typical extruder contains one (or two) flighted screws which rotate within a cylinder or “barrel”. The polyolefin is sheared between the barrel and the screw by the stresses caused by the rotation of the screw. In addition, the barrel of the extruder may be heated. The shear and/or heat cause the plastic to melt and the action of the flighted screw transports it along the length of the extruder. The molten plastic extrudate is then forced through a die to form the desired plastic part.

### EXAMPLES

It has been observed that the performance of a polymer process aid (“PPA”) in reducing melt defects in extrudates is influenced by the shear rate at the extruder die. Accordingly, experiments were conducted over a range of shear rates of commercial interest. A generally accepted equation for the estimation of shear rate at the die is given by:

$$γ = \frac{2 Q ( S + 2 )}{ρ π {d}^{2} D}$$

where
γ=shear rate (reciprocal seconds, s⁻¹);
ρ=density of polymer melt;
S=1/power law index;
d=die gap width;
D=diameter of extruder screw; and
Q=mass flow rate of polymer.

A generally accepted estimate of density for molten polyethylene is 0.76 grams per cubic centimeter and this value was used for all calculations.

A generally accepted value for power law index is 0.5 and this value was used in all calculations.

### Example 1

A “semi-commercial” sized blown film line (manufactured by the Battenfeld Gloucester Engineering Company of Gloucester, Mass.) was used to determine the effectiveness of PEG 35,000 as a polymer processing aid.

This film line has a standard output of greater than 100 pounds per hour and is equipped with a 50 horsepower motor on the extruder screw. The screw has a 2.5 inch diameter and a length/diameter (L/D) ratio of 24/1.

The film bubble is air cooled and the line should be operated at a blow up ratio (BUR) of between 2/1 and 4/1.

The line was fitted with an annular die having a gap of 85 mils for the experiments. The extruder was operated with a mass flow rate “aiming point” of about 115-120 pounds per hour (corresponding to a shear rate of about 105 s⁻¹).

The following polyolefins and additives were used.

The polyolefin was a commercially available linear low density polyethylene having a density of about 0.918 g/cm³ and a melt index, 12 Of 0.55 g/10 minutes (as determined by ASTM test method D1238, Condition E at 190° C. using a 2 kg weight) sold under the tradename NOVAPOL FP 015-A by NOVA Chemicals Corporation. The polyolefin contained a conventional primary antioxidant (a hindered phenol); a conventional secondary antioxidant (a phosphite); a fatty amide slip additive; and silica antiblock.

The polyethylene glycol used in the inventive experiment was a commercially available product having a reported molecular weight of 35,000 and sold under the tradename Polyglykol 35,OOOS by Clariant.

A concentration of 500 parts per million by weight (ppm) of the PEG 35,000 was observed to be sufficient to cause melt fracture to “clear” after 10 to 30 minutes of operation.

As a general guideline, a PPA may be regarded as providing very good performance if melt fracture is eliminated after 60 minutes of operation.

The minimum concentration of PEG 35,000 required to clear melt fracture was not optimized but a second experiment at a lower PEG 35,000 concentration (namely 300 ppm) was not sufficient to clear melt fracture after 60 minutes.

### Examples 2-4

### General

A commercial size blown film line (manufactured by the Macro Engineering Company) was used in these Examples.

This “Macro” film line has a standard output of greater than 250 pounds per hour. The extruder is equipped with a 150 horsepower motor. The extruder screw has a diameter of 3.5″ and an UD ratio of 30/1.

A dual lip air cooling ring provides bubble cooling.

The line should be operated at a BUR of between 2.5/1 and 4/1.

This Macro film line is also equipped with a commercially available instrument to measure the thickness of the polyethylene film being produced. The instrument (which is known to those skilled in the art) takes film thickness measurements around the circumference of the film bubble by way of monitoring capacitance (which is proportional to film thickness).

The die diameter for all experiments was 8 inches.

It is desirable for the film thickness to remain close to the aiming point (and the performance of the PPA may influence the control of extruded film thickness).

However, two different dies (having die gaps of 85 mils and 50 mils, respectively) were used to test the influence of different shear rates on the performance of the PPA systems.

The experiments of Example 2 were conducted using a die with an 85 mil gap and at a mass flow rate (aiming point) of about 250 pounds per hour, corresponding to a shear rate at the die of about 110 s⁻¹.

The experiments of Example 3 were conducted using the same die gap (85 mil) and a higher mass flow rate (aiming point) of about 450 pounds per hour, corresponding to a shear rate of about 200 s⁻¹.

The experiments of Example 4 used a narrower die gap (50 mils) and a mass flow rate of about 245 pounds per hour, corresponding to a shear rate of about 315 s⁻¹.

The inventive experiments of Examples 2 to 4 all used 1,500 parts per million of high molecular weight polyethylene glycol (Polyglykol 35,000S) as the PPA.

Control experiments for Examples 2 to 4 were conducted with 1,500 ppm of a conventional PPA system consisting of a blend of fluoroelastomer (Dynamar 9613, from 3M) and low molecular weight PEG (CARBOWAX 8000) in a 1/2 weight ratio (i.e. 1,000 ppm of fluoroelastomer and 500 ppm of CARBOWAX 8000).

### Example 2

### Low Shear Rate

As previously noted, inventive experiments were conducted using the same polyolefin (FP 015-A) and 1,500 ppm of high molecular weight PEG (Polyglykol 35,000S) used in Example 1.

Control experiments, using a conventional PPA (namely a mixture of fluroelastomer and PEG having a molecular weight of about 8,000 in a 1/2 ratio) were also conducted. The concentration of this control (conventional) PPA system was 1,500 ppm.

The following parameters were monitored during the experiments: film output (pounds per hour), film thickness and extruder pressure. All experiments were conducted on the “Macro” film line described above.

The data are shown in Tables 2.

The data shows that extruder pressure decreased with time for both PPA systems. However, the inventive experiments showed the best reduction in extruder pressure.

The film thickness also were similar for both PPA systems (with the inventive system showing somewhat better control of film thickness). The film quality (visual appearance) was judged to be similar for both PPA systems and the time to “clear melt fracture” was also similar.

TABLE #2

| | | | | | |
|---|---|---|---|---|---|
| | | | Average | Maximum | Minimum |
| Time | Pressure | Output | Thickness | Thickness | Thickness |
| (min) | (psi) | (lbs/hr) | (mil) | (mil) | (mil) |

(Inventive)

| | | | | | |
|---|---|---|---|---|---|
| 10 | 4342 | 242 | 0.975 | 1.057 | 0.888 |
| 30 | 4184 | 249 | 1.008 | 1.089 | 0.893 |
| 60 | 3943 | 250 | 1.004 | 1.105 | 0.864 |
| 90 | 3849 | 253 | 1.011 | 1.123 | 0.828 |
| 120 | 3786 | 249 | 0.99 | 1.083 | 0.873 |
| 150 | 3744 | 246 | 1.001 | 1.108 | 0.905 |
| 180 | 3796 | 250 | 0.997 | 1.084 | 0.905 |
| 210 | 3754 | 249 | 0.994 | 1.078 | 0.887 |
| 240 | 3786 | 251 | 1.005 | 1.106 | 0.874 |

(Comparative)

| | | | | | |
|---|---|---|---|---|---|
| 10 | 4352 | 247 | 0.987 | 1.051 | 0.9 |
| 30 | 4426 | 250 | 1.002 | 1.083 | 0.929 |
| 60 | 4279 | 250 | 1.005 | 1.125 | 0.885 |
| 90 | 4184 | 251 | 0.997 | 1.087 | 0.899 |
| 120 | 4132 | 249 | 1.004 | 1.097 | 0.891 |
| 150 | 4090 | 252 | — | — | — |
| 180 | 4059 | 250 | 1.004 | 1.076 | 0.894 |
| 210 | 4038 | 251 | 1.001 | 1.071 | 0.89 |
| 240 | 4006 | 250 | 1 | 1.078 | 0.885 |

### Example 3

### Medium Shear Rate

The experiments of this example were conducted on the “Macro” film line using the same polyolefin (FP 015-A) and PPAs (namely Polyglykol 35,000S for the inventive experiments and the conventional PPA (a 1/2 Fluoroelastomer/PEG800 blend) for the control experiments used in Example 2.

The other experimental conditions were also similar to those of Example 2, except that the shear rate at the die lip was increased by increasing the polymer mass flow rate to about 450 lbs per hour (aiming point) giving a shear rate of about 200 s⁻¹.

The time to “clear melt fracture” was essentially the same for both in inventive and control PPAs.

Experimental data are provided in Table 3. Once again, the inventive experiment showed an improvement in extruder pressures in comparison to the control experiments.

TABLE #3

| | | | | | |
|---|---|---|---|---|---|
| | | | Average | Maximum | Minimum |
| Time | Pressure | Output | Thickness | Thickness | Thickness |
| (min) | (psi) | (lbs/hr) | (mil) | (mil) | (mil) |

(Inventive)

| | | | | | |
|---|---|---|---|---|---|
| 10 | 4552 | 412 | — | — | — |
| 30 | 4583 | 447 | 0.993 | 1.126 | 0.833 |
| 60 | 4384 | 452 | 1.004 | 1.1 | 0.874 |
| 90 | 4384 | 446 | 0.993 | 1.12 | 0.784 |
| 120 | 4310 | 448 | 0.999 | 1.147 | 0.829 |
| 150 | 4352 | 451 | 1 | 1.167 | 0.804 |
| 180 | 4237 | 446 | 1.009 | 1.145 | 0.839 |
| 210 | — | — | — | — | — |
| 240 | 4237 | 449 | — | — | — |

(Comparative)

| | | | | | |
|---|---|---|---|---|---|
| 10 | 4761 | 438 | 0.981 | 1.053 | 0.924 |
| 30 | 4761 | 448 | 1.001 | 1.078 | 0.902 |
| 60 | 4709 | 450 | 1.005 | 1.101 | 0.83 |
| 90 | 4677 | 447 | 1.004 | 1.107 | 0.836 |
| 120 | 4646 | 450 | 1.005 | 1.079 | 0863 |
| 150 | 4667 | 449 | 0.999 | 1.081 | 0.87 |
| 180 | 4635 | 450 | 1.002 | 1.078 | 0.884 |
| 210 | 4604 | 450 | 1.004 | 1.085 | 0.84 |
| 240 | 4594 | 448 | 1 | 1.085 | 0.863 |

### Example 4

### High Shear Rate

These experiments were conducted on the “Macro” film line using the same materials and conditions used above, except that (i) the shear rate at the die lip was increased by decreasing the width of the die gap to 50 mils; and (ii) the mass flow rate (aiming point) was reduced to about 245 lbs per hour giving a shear rate of about 315 s⁻¹.

The time to “clear melt fracture” was essentially the same for both in inventive and control PPAs.

The data are shown in Table 4. Once again, the inventive PPA showed improved extruder pressures in comparison to the conventional/control PPA.

TABLE 4

| | | | | | |
|---|---|---|---|---|---|
| | | | Average | Maximum | Minimum |
| Time | Pressure | Output | Thickness | Thickness | Thickness |
| (min) | (psi) | (lbs/hr) | (mil) | (mil) | (mil) |

(Inventive)

| | | | | | |
|---|---|---|---|---|---|
| 10 | 3503 | 250 | 0.991 | 1.07 | 0.925 |
| 30 | 3692 | 251 | 0.997 | 1.083 | 0.924 |
| 60 | 3492 | 251 | 1.009 | 1.132 | 0.928 |
| 90 | 3419 | 250 | 1.01 | 1.135 | 0.911 |
| 120 | 3387 | 251 | 1.005 | 1.099 | 0.88 |
| 150 | 3324 | 253 | 1.005 | 1.115 | 0.864 |
| 180 | 3251 | 248 | 1.005 | 1.093 | 0.879 |
| 210 | 3251 | 251 | 0.994 | 1.094 | 0.86 |
| 240 | 3230 | 250 | 1.005 | 1.111 | 0.856 |

(Comparative)

| | | | | | |
|---|---|---|---|---|---|
| 10 | 3775 | 245 | 1.006 | 1.112 | 0.928 |
| 30 | 3775 | 250 | 1.006 | 1.102 | 0.935 |
| 60 | 3723 | 249 | 0.991 | 1.163 | 0.829 |
| 90 | 3681 | 252 | 1.006 | 1.166 | 0.816 |
| 120 | 3650 | 251 | 0.994 | 1.15 | 0.795 |
| 150 | 3639 | 249 | 1.006 | 1.158 | 0.806 |
| 180 | 3608 | 251 | 0.991 | 1.124 | 0.828 |
| 210 | 3597 | 249 | 1.002 | 1.172 | 0.836 |
| 240 | 3587 | 249 | 0.992 | 1.159 | 0.83 |

1. An extrudable composition for the manufacture of thermoplastic film comprising:
A) a thermoplastic polyolefin polymer; and
B) from 100 to 2000 parts per million by weight of polyethylene glycol; characterized in that said polyethylene glycol has a weight average molecular weight of from 10,000 to 50,000, and further characterized in that said composition is substantially free of fluoropolymers.

2. The composition of claim 1 wherein said thermoplastic polyolefin polymer is polyethylene.

3. The composition of claim 2 wherein said polyethylene is a thermoplastic copolymer of ethylene with at least one alpha olefin selected from the group consisting of butene-1, hexene-1, methyl pentene-1 and octene.

4. The composition of claim 3 wherein said polyethylene has a melt index, 12, of from 0.5 to 5 grams per 10 minutes.

5. The composition of claim 2 wherein said composition further contains a hindered phenol primary antioxidant and a phosphorus-containing secondary antioxidant.

6. A process for the extrusion of thermoplastic polyolefin comprising admixing with said thermoplastic polyolefin a polyethylene glycol having a molecular weight of greater than 20,000 and extruding said polyolefin and polyethylene glycol in a melt extrusion process.

7. The process of claim 6 wherein the concentration of said polyethylene glycol is from 200 to 2,000 parts per million by weight based upon the weight of said polyolefin.

8. The process of claim 6 wherein said polyolefin is polyethylene.
